(19) United States
(12) Patent Application Publication
(10) Pub. No.: US 2026/0003161 A1
(43) Pub. Date: Jan. 1, 2026

(54) INFORMATION HANDLING SYSTEM CAMERA LENS WITH EIGHT ELEMENTS FOR LOW DISTORTION WIDE FIELD OF VIEW

(71) Applicant: Dell Products L.P., Round Rock, TX (US)

(72) Inventors: Yi-Hsien Lin, Taipei City (TW); Chih-Hao Kao, Singapore (SG); Chien-Chih Liao, Taipei City (TW)

(73) Assignee: Dell Products L.P., Round Rock, TX (US)

(21) Appl. No.: 18/754,708

(22) Filed: Jun. 26, 2024

(51) Int. Cl. G02B 13/00; G02B 9/64; G06F 1/16

(52) U.S. Cl. CPC G02B 13/0045; G02B 9/64; G06F 1/1605

(57) ABSTRACT

An information handling system camera provides a 117 degree field of view with low distortion by capturing visual images through a lens having eight lens elements. The first lens element closest to the object, the third lens element and the sixth lens element each have a glass material, the remaining lens elements have a plastic material. The first two lens elements and the last lens element each have a negative refractive power and the remaining lens elements have a positive refractive power. Lens elements two and four through eight each have aspherical surfaces.

### BACKGROUND OF THE INVENTION

### Field of the Invention

The present invention relates in general to the field of information handling system cameras, and more particularly to an information handling system camera lens with eight elements for low distortion wide field of view.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems generally process information with processing components built into a housing and present the information as visual images at a display. Portable information handling systems integrate a display and a power source in a portable housing to support mobile operations. Desktop information handling systems typically rely on peripheral displays to present the information. Portable information handling systems will generally support presentation of visual images at both the integrated display and at peripheral displays. One type of portable information handling system has a convertible configuration that includes multiple separate housing portions that couple to each other so that the system converts between closed and open positions. For example, a main housing portion integrates processing components and a keyboard and rotationally couples with hinges to a lid housing portion that integrates a display. In a clamshell position, the lid housing portion rotates approximately ninety degrees to a raised position above the main housing portion so that an end user can type inputs while viewing the display. After usage, convertible information handling systems rotate the lid housing portion over the main housing portion to protect the keyboard and display, thus reducing the system footprint for improved storage and mobility. Another type of portable information handling system has a tablet configuration with the display coupled over the processing components in a planar housing.

Information handling systems provide a convenient communication tool. Specifically, by including a camera with the information handling system an end user can readily participate in a videoconference communicated through the internet. The camera captures a field of view at the display so that an end user viewing the display to participate in the videoconference has an image of his face captured while viewing other participants to the videoconference at the display. One difficulty with this approach is that a limited space is typically available at the display where a camera can be located. In a display bezel, the camera lens has a limited depth so that a field of view that is sufficient to capture an end user viewing the display often involves a fisheye type of lens that tends to distort the edges of the captured visual image and has difficulty when capturing visual images in low light. To meet quality constraints for captured visual images, a camera should have a larger aperture with Fno of less than 2.0 and distortion of less than 10%. Applicant's “Information Handling System Camera Lens with Eight Elements for Improved Aperture and Reduced Blur,” filed on Feb. 21, 2024, by Lin et al., U.S. application Ser. No. 18/583,469, incorporated herein as if fully set forth, offers a solution that improves visual image capture.

In some instances, information handling systems operate with external devices to support videoconferencing. For example, enterprises often deploy videoconferencing equipment to conference rooms so that an entire room is leveraged to interact in a videoconference. A videoconferencing bar attaches to a display or television to capture an image of all places at a conference room table. In many instances, the videoconference bar includes a camera with a wide field of view lens to capture individuals seated at the table near the camera, such as a field of view of greater than 110 degrees. Visual images captured at the edges of the lens tend to distort, which degrades the visual image of the individuals near the camera. One common goal is to minimize distortion to 10% or less, however, even at these levels the distortion can disrupt the end user experience in viewing individuals captured by the camera.

### SUMMARY OF THE INVENTION

Therefore, a need has arisen for a system and method which assembles a lens from plural lens elements to improve wide field of view image capture with reduced distortion.

In accordance with the present invention, a system and method are provided which substantially reduce the disadvantages and problems associated with previous methods and systems for capturing visual images through a lens. The lens has eight elements to capture light in a wide field of view with reduced distortion at the edges of the field of view.

More specifically, an information handling system processes information with a processor that executes instructions in cooperation with a memory that stores the instructions and information, such as to execute a videoconferencing application that communicates an audiovisual stream through a network. A camera at the information handling system captures a visual image at a field of view for the display viewing position, such as a camera coupled in a peripheral display front. A lens included in the camera has eight lens elements to capture quality visual images with reduced distortion in a wide field of view, such as up to 120 degrees. An image side lens element, a third lens element and a sixth lens element each have a glass material, including one lens element of molding glass; the remaining lens element having a plastic material. The two lens elements closest the object side and the lens element closest the image sensor have negative refractive power; the remaining lens elements have positive refractive power. Lens elements 1 and three have spherical surfaces; the remaining lens elements have aspherical surfaces. The arrangement of lens elements provides an F-number of 2.2 or less with distortion of less than 6% for wide field of view visual image capture.

The present invention provides a number of important technical advantages. One example of an important technical advantage is that a small footprint lens captures high quality visual images in a wide field of view with limited distortion, an F-number of 2.2 and image sensor of 1/1.8 inches and distortion is kept below 6%.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an information handling system interfaced with plural types of cameras having an improved lens to capture visual images in low light with reduced distortions at a wide field of view;

FIG. 2 depicts a side sectional view of an example of a camera having a lens that offers a reduced footprint with a wide field of view and capability to capture images with reduced distortion;

FIG. 3 depicts a side sectional view of the camera lens having a reduced footprint with a wide field of view and capability to capture images with reduced distortion;

FIG. 4 depicts a table that provides example specifications for a lens depicted by FIG. 3 having lens elements L1 through L8 and lens surfaces S1 through S19;

FIG. 5 depicts a table that provides example specifications for a lens depicted by FIG. 3 having spherical L1, L3 and L8 elements and aspherical L2 and L4 through L7 elements;

FIG. 6 depicts a graph of an example of field curvature and distortion for the example embodiment of lens shown in FIGS. 3-5;

FIG. 7 depicts a graph of an example of polychromatic diffraction MTF for the lens modulus versus spatial frequency in cycles per mm;

FIG. 8 depicts a graph of an example of an optical transfer function for the lens modulus versus field in mm; and

FIG. 9 depicts a table of specifications of the example embodiment of the lens.

### DETAILED DESCRIPTION

An information handling system camera lens has eight lens elements to improve images captured with a wide field of view lens to have minimal distortion. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

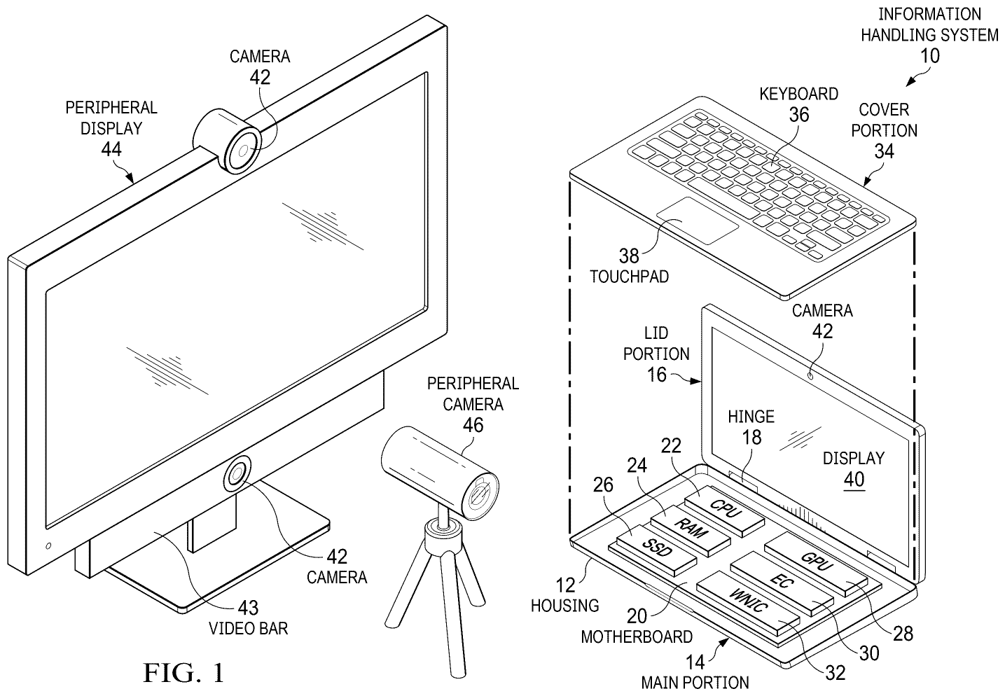

Referring now to FIG. 1, an information handling system 10 is depicted interfaced with plural types of cameras having an improved lens to capture visual images with reduced distortions through a wide field of view lens. In the example embodiment, information handling system 10 is built in a portable housing 12 having a main portion 14 rotationally coupled with a lid portion 16 by a hinge 18. A motherboard 20 couples in main portion 14 to interface processing components that cooperate to process information. For example, a central processing unit (CPU) 22 executes instructions to process information in cooperating with a random access memory (RAM) 24 that stores the instructions and information. A solid state drive (SSD) 26 provides persistent storage of the instructions and information, such as an operating system that manages system operations and applications that run over the operating system to perform desired processing tasks, such as a videoconferencing application. A graphics processing unit (GPU) 28 further processes information to generate visual images for presentation at a display. An embedded controller 30 manages system operations at a physical level, such as application of power, thermal constraints and interactions with I/O devices. A wireless network interface controller (WNIC) 32 communicates with external devices, such as through WIFI and BLUETOOTH. A housing cover portion 34 couples over main portion 14 to support a keyboard 36 and touchpad 38 that accept end user inputs.

During operation, information handling system 10 presents visual information as visual images at an integrated display 40 built into housing lid portion 16. Alternatively, visual images are presented at a peripheral display 44, such through a cable or wireless communication interface. When executing a videoconferencing application, visual information of conference participants received through WNIC 32 are presented by GPU 28 at display 40 and/or peripheral display 44 so that an end user viewing the displays looks at the participants. A camera 42 included in housing lid portion 16 captures the end user face when looking at integrated display 40. A camera 42 included in peripheral display 44 captures the end user face when looking at peripheral display 44. A peripheral camera 46 sets up separate from peripheral display 44 to capture visual images from alternative angles, such as on a stand in front of peripheral display 44 or clipped onto a side of peripheral display 44. A video bar 43 couples to one side of peripheral display 44 and includes a camera 42 to capture visual images as a videoconference stream. In an office environment, cameras 42 and 46 should have a small footprint with a wide field of view and a capability to capture images in a low light environment with reduced distortion. In a conference room configuration, video bar 43 couples to a television or display to capture a videoconference stream of an entire conference room. Video bar 43 may include a processor, memory and WNIC that interface with peripheral display 44 to offer a standalone videoconference solution, with video bar 43 camera 42 capturing visual images to send to other videoconference network nodes and presenting visual images at peripheral display 44 that are received from cameras at other network nodes. Camera 42 in video bar 43 has a wide field of view of 110 degrees or more to ensure that table seats near the video bar are captured as part of the visual images. The wide field of view introduces perspective distortion at the edges of the captured visual images due to magnification effects versus distances to different locations at a human face captured on the edges of the visual image. As a result, participants in the video conference can appear distorted and unnatural along the outer edges of the captured visual image.

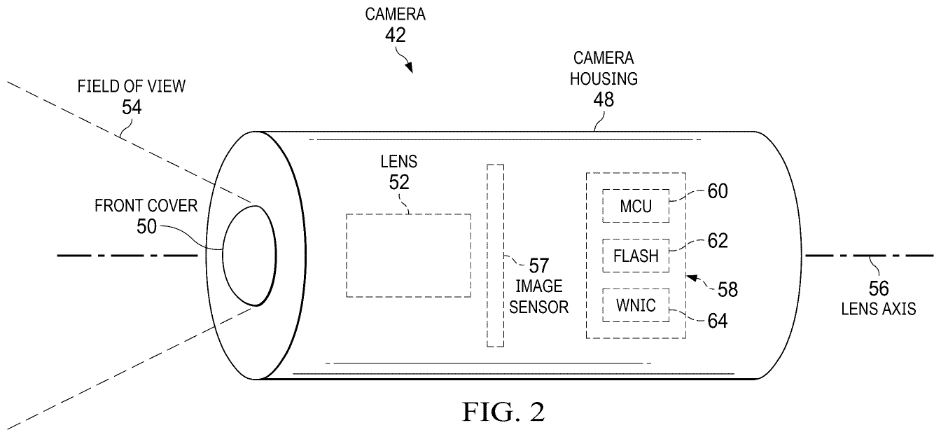

Referring now to FIG. 2, a side sectional view depicts an example of a camera 42 having a lens that offers a reduced footprint with a wide field of view and capability to capture images with reduced distortion. In the example embodiment, camera 42 is built into a camera housing 48 that couples to a peripheral display. Alternative embodiments may use different dimensions to fit into a portable information handling system housing or a peripheral camera. A lens 52 having plural lens elements accepts light along a lens axis 56 through a front cover 50 of an object in a field of view 54. Lens 52 focuses the light as an image at an image sensor 57, which captures the light as digital information. A circuit board 58 interfaces with image sensor 57 so that a processing resource, such as an MCU 60 executing instructions in a flash memory 62, can control capture of visual images for communication through a wireless network interface controller 64.

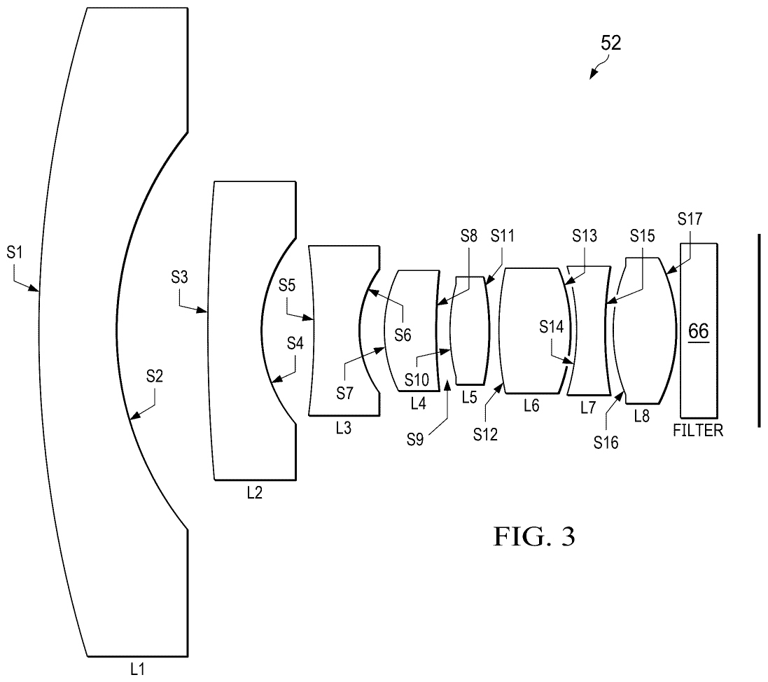

Referring now to FIG. 3, a side sectional view depicts the camera lens 52 having a reduced footprint with a wide field of view and capability to capture images with reduced distortion. Lens 52 has eight lens elements L1 through L8 that cooperate to direct light from an object side at lens element L1 through a filter 66 at an image side of lens element L8. Each of lens elements L1 through L8 has an object-side surface and an image side surface labeled S1 through S17 with a gap labeled S9. The object side lens L1 and the image side lens L8 each have a negative refractive power. The second lens element L2 also has a negative refractive power. The remaining lens elements L3 through L7 each have a positive refractive power. The lens structure is 2 glass, 1 molding glass and 5 plastic lenses. In the example embodiment, L1, L3 and L6 are glass elements; L2, L4-L5 and L7-L8 are plastic elements. Lens L1 has a refractive index of 1.923 and focal length of −21.424. L2 has a refractive index of 1.645 and a focal length of −8.757. L3 has a refractive index of 1.517 and a focal length of 7.889. L4 has a refractive index of 1.573 and a focal length of 31.770. L5 has a refractive index of 1.544 and a focal length of 6.412. L6 has a refractive index of 1.809 and a focal length of 17.748. L7 has a refractive index of 1.671 and a focal length of 25.952. L8 has a refractive index of 1.544 and a focal length of −7.650. L1 has −7<f1/f<−8 fit to support the field of view of up to 117 degrees. f1 refers to the L1 focus length, and F refers to the focus length of lens 52. The arrangement of lens elements targets an F-number of 2.2 or less to achieve minimal distortion and a small field curvature. In the example embodiment, with an F-number of 2.2, good image quality is provide at a 1/1.8″ sensor at a distortion of less than 6%.

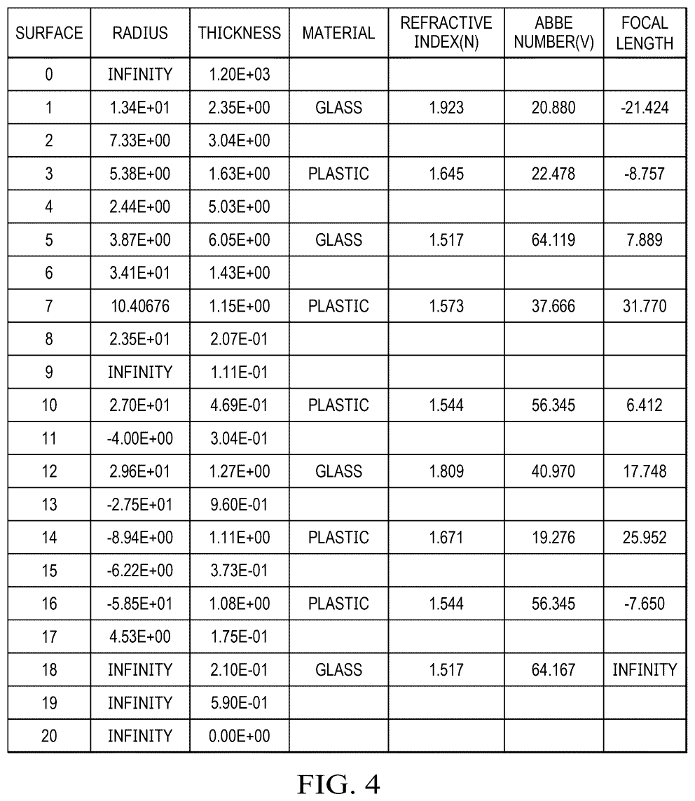

Referring now to FIG. 4, a table provides example specifications for a lens depicted by FIG. 3 having lens elements L1 through L8 and lens surfaces S1 through S17. The table provides example dimensions for surface radius, thickness and separation, material, refractive index, Abbe number and focal length. In the example embodiment, the filter has a thickness of 0.21 mm. Lens 52 has an effective focal length of 2.74 mm, a relative illumination of 35.8%, a back focal length of 0.962 mm, a total track length of 27.551 mm, and a chief ray angle of 37 degrees. The horizonal field of view is 82 degrees; the vertical field of view is 51.3 degrees and the maximum image circle is 9.252 mm. In alternative embodiments, adjustments to the size and spacing of the lens element provide the lens to fit into various camera footprints.

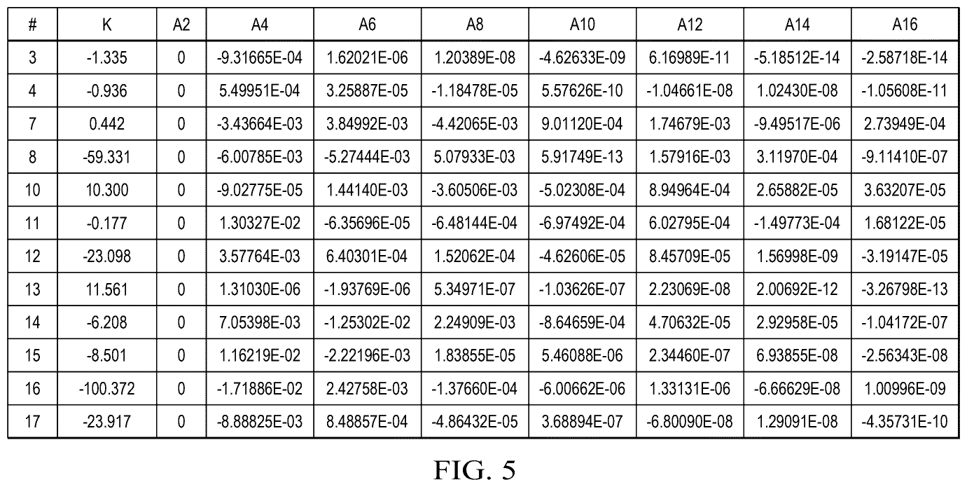

Referring now to FIG. 5, a table provides example specifications for a lens depicted by FIG. 3 having spherical L1 and L3 elements and aspherical L2 and L4 through L8 elements. The depicted aspherical coefficients for surfaces S3-S4 and S7-S17 target a lens performance of a 1/1.8″ sensor and 156 lp/mm at a 45% modulation transfer function. The depicted aspherical coefficients keep good performance for all fields of view to minimize distortion.

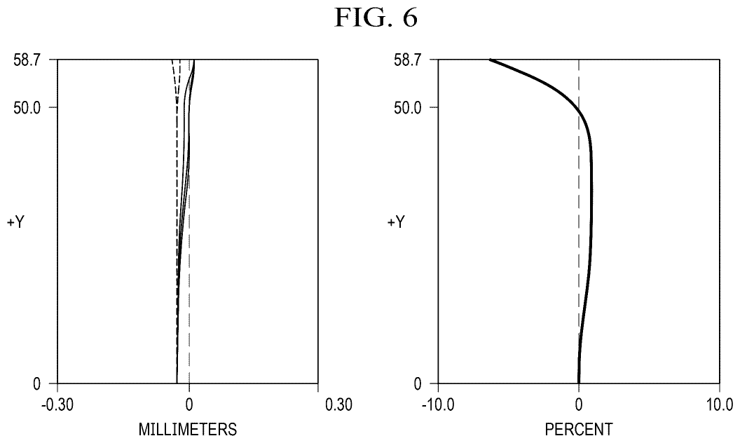

Referring now to FIG. 6, a graph depicts an example of field curvature and distortion for the example embodiment of lens shown in FIGS. 3-5. The arrangement of lens elements produces less than 6% distortion, which is essentially imperceptible by the human eye.

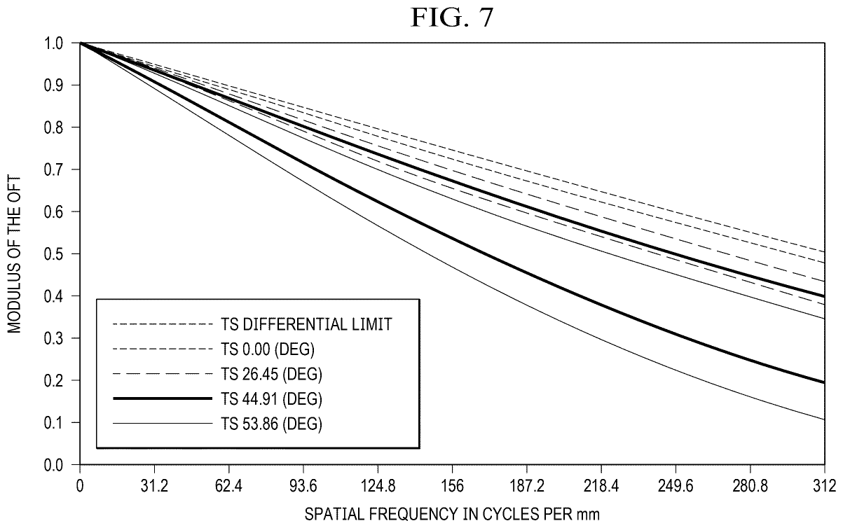

Referring now to FIG. 7, a graph depicts an example of polychromatic diffraction MTF for the lens modulus versus spatial frequency in cycles per mm.

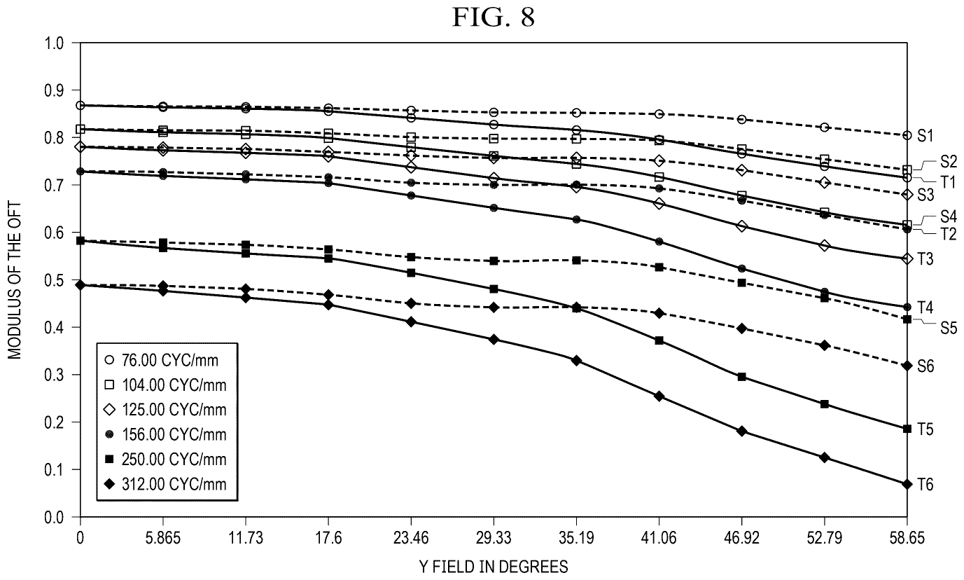

Referring now to FIG. 8, a graph depicts an example of an optical transfer function for the lens modulus versus field in mm.

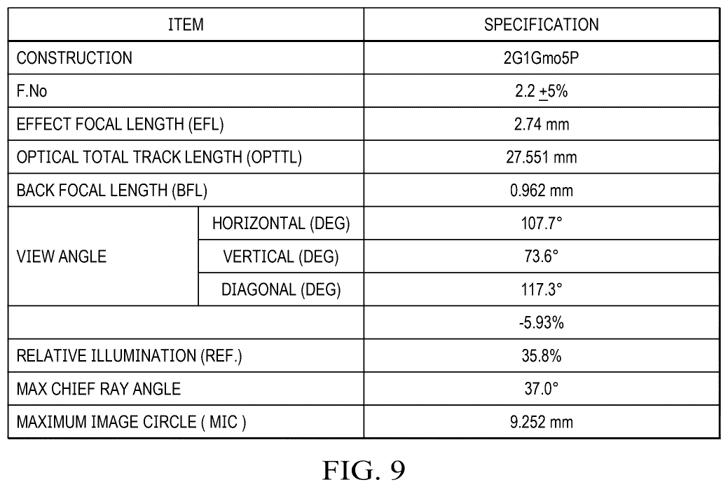

Referring now to FIG. 9, a table depicts specifications for an example embodiment of the camera lens. The lens has an effective focal length of 2.74 mm and F-number of 2.2. Optical distortion is less than 6% and relative illumination is 35.8%. The focal back length is 0.962 mm and the total track length is 27.551 mm. The chief ray angle is 37 degrees. The maximum image circle is 9.252 mm. In alternative embodiments, adjustments to the specifications may be made to achieve particular goals.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
a processor coupled in the housing and operable to process information;
a memory coupled in the housing and interfaced with the processor, the memory operable to store the information;
a display interfaced with the processor and operable to present the information as visual images; and
a camera having a field of view positioned to capture a visual image of an end user viewing the display, the camera having a lens with eight lens elements ordered from an object side to an image side:
a first lens element having negative refractive power;
a second lens element having negative refractive power;
a third lens element having positive refractive power;
a fourth lens element having positive refractive power;
a fifth lens element having a positive refractive power;
a sixth lens element having a positive refractive power;
a seventh lens element having a positive refractive power; and
an eighth lens element having a negative refractive power.

2. The information handling system of claim 1 wherein:
the first lens element, the third lens element and the sixth lens element are glass; and
the second lens element, the third lens element through the fifth lens element and the seventh lens element through the eighth lens element are plastic.

3. The information handling system of claim 1 wherein the total track length of the lens is 27.551 mm.

4. The information handling system of claim 1 wherein the F-number of the lens is 2.2 or less.

5. The information handling system of claim 4 wherein the effective focal length of the lens is 2.74 mm or less.

6. The information handling system of claim 5 having optical distortion of less than 6%.

7. The information handling system of claim 1 wherein the first lens element has a fit of −7<f1/f<−8.

8. The information handling system of claim 1 wherein plural of the lens elements have aspherical coefficient surfaces to achieve 156 lp/mm at 45% modulation transfer function.

9. The information handling system of claim 8 wherein the lens has at least a 110 degree field of view.

10. The information handling system of claim 1 wherein the lens elements two and four through eight are aspheric.

11. A camera lens comprising:
a first lens element having negative refractive power;
a second lens element having negative refractive power;
a third lens element having positive refractive power;
a fourth lens element having positive refractive power;
a fifth lens element having a positive refractive power;
a sixth lens element having a positive refractive power;
a seventh lens element having a positive refractive power; and
an eighth lens element having a negative refractive power.

12. The camera lens of claim 11 wherein:
the first lens element, the third lens element and the sixth lens element are glass; and
the second lens element, the third lens element through the fifth lens element and the seventh lens element through the eighth lens element are plastic.

13. The camera lens of claim 11 wherein the total track length of the lens is 27.551 mm.

14. The camera lens of claim 11 wherein the F-number of the lens is 2.2 or less.

15. The camera lens of claim 11 wherein the effective focal length of the lens is 2.74 mm or less.

16. The camera lens of claim 15 having optical distortion of less than 6%.

17. The camera lens of claim 11 wherein the first lens element has a fit of −7<f1/f<−8.

18. The camera lens of claim 11 wherein plural of the lens elements have aspherical coefficient surfaces to achieve 156 lp/mm at 45% modulation transfer function.

19. The camera lens of claim 18 wherein the lens has at least a 117 degree field of view.

20. The camera lens of claim 11 wherein the lens elements two and four through eight are aspheric.
